(19) United States
(12) Patent Application Publication
(10) Pub. No.: US 2007/0206208 A1
(43) Pub. Date: Sep. 6, 2007

(54) Printing block assigning means in a rotary printing machine

(76) Inventors: Wolfgang Dennstedt, Bern (CH); Thomas Zehnder, Bern (CH)

Correspondence Address: RATNERPRESTIA, P O BOX 980, VALLEY FORGE, PA, 19482-0980, US

(21) Appl. No.: 11/601,161

(22) Filed: Nov. 17, 2006

(30) Foreign Application Priority Data
Nov. 18, 2005 (DE) 10 2005 055 116.5

(51) Int. Cl. G06K 15/00

(52) U.S. Cl. 358/1.12

(57) ABSTRACT

A printing block assigning system for one or more block cylinders of a rotary printing machine, comprising: a printing block storage comprising storage spaces for printing blocks which can be deposited on the block cylinder; a detector for each storage space for detecting a printing block respectively occupying the storage space and outputting a detection signal; an identification component for receiving, processing and storing information which individually identifies the respective printing blocks is situated outside the printing block storage; the detection signals of the detectors are supplied to the identification component; and the identification component detects whether the printing blocks are situated on the storage spaces respectively assigned to them, on the basis of a comparison between the information received from the printing blocks and the received detection signals.

This application claims priority to German Patent Appln. No. 10 2005 055 116.5 filed Nov. 18, 2005, which is incorporated in its entirety by reference herein.

### BACKGROUND OF INVENTION

1. Technical Field

The invention relates to a printing block assigning means of a rotary printing machine or roller rotary printing machine, which makes it possible, after a printing block has been inserted onto a storage space, to directly determine whether the printing block is lying on the correct storage space assigned to it.

2. Description of the Related Art

DE 103 14 340 B3 discloses a device for storing a hoist to be exchanged in a cylinder of a printing machine. Prior to changing, the hoist—for example, a printing block—is stored in a shaft. This shaft, which is nothing more than a storage space of a printing block storage, comprises at least one code reader which is arranged in the shaft and identifies the hoist stored in the shaft on the basis of a feature attached to the hoist. The information read is compared with an occupancy plan; if there are discrepancies, a warning signal is generated before the hoist is assembled on the cylinder. Consequently, the device of DE 103 14 340 B3 comprises at least one code reader for each storage space/shaft. This means that, for a cylinder comprising six hoists in the longitudinal direction and two hoists in the circumferential direction, at least twelve code reading devices are needed for each block cylinder. For a printing unit comprising four block cylinders, that means at least 48 code readers for each printing unit. These numerous code readers are not only a considerable cost factor but also require a high outlay in maintenance and repairs.

### SUMMARY OF THE INVENTION

It is an object of the invention to provide a cost-effective but reliable storage control for printing blocks in a printing block storage.

The invention relates to a printing block assigning means for one or more block cylinders of a rotary printing machine comprising a printing block storage with storage spaces for printing blocks which are to be deposited on the block cylinder. Each of the storage spaces comprises its own detector which is capable of detecting the presence of a printing block in the printing block storage and when occupied, outputs a corresponding detection signal. The printing block assigning means further comprises an identification means, e.g. a barcode reader, arranged outside the printing block storage, a reading device for reading electronically encrypted data or a chip reading device for receiving, processing and storing information stored on the printing block which is capable of unambiguously identifying the respective printing block.

Once the data specific to the printing block have been received, the printing block is stored by the machine operator, or for example automatically by a printing block manipulator, on a storage space. The detector of the then occupied storage space transmits the detection signal to the identification means. On the basis of this detection signal and the data taken from the printing block, the identification means can unambiguously determine whether the printing block read has been stored at the correct storage location. To this end, the identification means stores an occupancy plan of the block cylinders, or the identification means communicates with a means on which the occupancy plan is stored. This occupancy plan reflects the intended occupancy of the block cylinders and serves to identify deviations between the intended storage space and the actual storage space of each individual block cylinder for the identification means. The detection signals are supplied to the identification means via wire connections or wirelessly or by other suitable transmission paths, such as for example glass fibre.

In a preferred embodiment, the identification means comprises one or more sensors which are attached to the machine frame in the vicinity of the printing block storages or another suitable location and read and relay only the information provided on the printing block. The identification means further comprises a connection between the sensor or sensors and a central machine controller or parts of the central machine controller which can relay data from the sensor to the machine controller via a wire connection or wirelessly or in any other practicable way. Lastly, the identification means comprises storage and processing elements, e.g. microprocessors, which are part of the machine controller and in which the occupancy plan for the next production is stored and which are capable of comparing the predetermined storage space occupancy with the data transmitted from the sensor and deciding on the basis of this comparison which storage space the printing block for which data has just been transmitted is assigned to. Alternatively, the data processing means of the identification means is/are assigned to a printing unit or printing tower controller instead of the central machine controller, and the occupancy plan is stored and the data processed in said printing unit or printing tower controller, in the form described above. Lastly, the possibility is also not to be excluded that the data processing means is situated outside the printing machine, for example in a central computer for monitoring multiple printing machines.

Equally, it is also possible for the sensor and the data processing means to form a structural unit, such that the information from the printing block and the detection signal of the detector of the storage space can be received independently of the central machine controller or the printing tower or printing unit controller, and both items of information can be compared with the occupancy plan stored in the identification means.

An identification means or a sensor of an identification means can be respectively assigned to a block cylinder, a printing unit comprising multiple block cylinders, an H-bridge for example or a printing tower. Preferably, however, one identification means is used for every two printing locations arranged successively with respect to the direction of feed of the machine. The printing locations can be satellite printing units for printing one side of a printing material web with for example four block cylinders each, rubber-rubber printing units with for example eight block cylinders each for printing both sides of a printing material web, or any other arrangement. When used in printing towers, the identification means is attached to the frame of the printing machine on at least one of the working levels between two printing towers, such that all the block cylinders of the two printing towers can be operated with one identification means. In this case, it is particularly preferable if at least two sensors of identification means are provided on at least one, preferably each, of the working levels from which the block cylinders of the printing units can be reached, in the immediate spatial vicinity of the printing block storages, such that the operator does not have to turn round when inserting the printing blocks into the printing block storage or storages and only has to move short distances, and the spatial distance from the identification means to the block cylinder or cylinders is small. Lastly, it is also conceivable for only a single identification means to be provided for an entire rotary printing machine.

When using multiple identification means, e.g. one for each printing bridge, each identification means operates independently of all the others. This means that operating staff can simultaneously read printing blocks on two or more identification means and insert these into the storage spaces. An incorrect occupancy at one reading point does not then stop an insertion at another location.

When using an identification means comprising multiple sensors which are each assigned for example to a printing unit, and comprising a collective data processing means, preferably only the sensor in whose effective range an incorrect occupancy is determined is respectively blocked, while printing block data can continue to be read at all the other sensors.

Only once the identification means has determined the correct storage for the printing block, by comparing the data of the printing block and of the detection signal of the storage space, is it ready to receive the data of a subsequent printing block. This means that an identification means can only monitor the correct or incorrect storage of a single printing block at any one time. Only when the correct storage of printing block has been confirmed is the identification means capable of receiving data of a subsequent block.

If there is no detection signal because a printing block has not been inserted, or if the identification means recognises on the basis of the detection signal that the printing block has been stored at an incorrect storage space, a signal which is perceptible by the senses is generated. Only once the recognised error has been corrected can the storage spaces continue to be loaded.

The signal which is perceptible by the senses can be a visible or audible signal or a visible and audible signal. Any other type of signal capable of attracting the attention of the operating staff can also be used.

Preferably, it is a visible signal, e.g. light-emitting diodes attached to the side of each storage space facing the operator. Said light-emitting diodes indicate to the operator the changing spaces necessary for the next production, i.e. the storage spaces which are to be occupied by new printing blocks, for example by a red light, i.e. only the contents of the storage spaces which show a red light have to be changed prior to the next production. This change can mean changing the printing plates, newly occupying a previously empty storage space or merely removing a printing block from a printing storage space which is not needed for the next production. A green light confirms that the storage space occupancy corresponds to the occupancy plan stored in the identification means and, when a storage space is occupied by a new printing block, i.e. when a previously empty space is occupied or within the context of a change, confirms that the printing block has been stored at the storage space assigned to it. The light-emitting diodes are switched by signals from the identification means.

Only when all the printing blocks for the next production are lying on their intended storage space, as confirmed by the identification means, does a blocking means release the printing blocks for a printing block change, wherein the blocking means can be an integrated part of the machine controller which in turn receives its information from the identification means, but can also be a simple operating button which the operator has to deliberately activate when the last printing block has been confirmed as lying on the storage space assigned to it. When the printing blocks are independently read at multiple locations on the printing machine, all the identification means and/or all the operators must confirm that all the printing blocks assigned to them have been correctly inserted at their target locations before the printing block change is released.

For receiving the information of the printing blocks, each printing block must be guided past the identification means before it is inserted into its storage space. This can be done by hand by the operating staff, semi-automatically or automatically. In order to store the printing blocks in their storage spaces as economically as possible, it is expedient for the identification means to be situated as close as possible to the printing block storage. It is also conceivable for the identification means to be a mobile means which is for example hand-held by the operating staff and is guided to the printing blocks in order to receive their information, for example a portable barcode reader. In this case, a way of inputting is provided on the identification means, by means of which the number or other designation of the printing unit/tower which is about to be loaded can be inputted. Alternatively, an encoded designation of the individual printing storages is also conceivable, which is received by means of the identification means before occupancy is started and activates the intended occupancy plan of the printing storage read, as stored in the identification means.

The detectors can be optical, mechatronic or electrical detectors, but can also be a Hall sensor for measuring a magnetic field or a means which responds to the weight of the inserted printing block, wherein the detectors are preferably configured such that they can only distinguish between the states “storage space empty” and “storage space occupied” and such that only the information “storage space occupied” is reported to the identification means by means of the detection signal.

One method of non-contact optical detection is for example a light barrier which recognises that the printing block has been inserted into the storage space and generates and emits the corresponding detection signal. Levers which are tipped when a printing block is inserted into a storage space and thus close an electrical contact, which in turn generates the detection signal, can for example serve as mechatronic detectors.

Preferably, however, the detectors are two spaced contacts, supplied with a current, which are closed when the printing block is inserted, wherein the printing block as a whole can consist of a conductive material, or can equally comprise a thin strip of a conductive material in or on its lower side facing the cylinder, said strip connecting the contacts to each other and thus closing the circuit. It is particularly preferred if only one of the two contacts of the storage space is supplied with a current, while the other contact serves as a neutral conductor. In this case, the inserted printing block generates a short-circuit, and the current of the short-circuit generates the detection signal. If multiple storage spaces for printing blocks are provided in one printing block storage, then it is preferred if the neutral conductors of all the storage spaces of the printing block storage are connected to each other and form a single neutral conductor. In this case, the detection signal can for example be formed by one green and one red light-emitting diode for each storage space, which are activated by the current of the short-circuit, wherein for example the red light-emitting diode is illuminated when the identification means determines that the wrong storage space has been occupied by a printing block, and the green light-emitting diode for example indicates that the storage space has been loaded with the correct printing block and the next printing block can be read at the identification means.

When using printing blocks which occupy more than one storage space, for example panoramic printing blocks, correctly storing the special printing block in the printing block storage generates two, but preferably only one, detection signal. This/these signal/s are supplied to the identification means in the same way as when occupying individual storage spaces. Here, too, the identification means decides, on the basis of the data taken for example from the panoramic printing block and the detection signals generated at the storage spaces and supplied to it, whether the panoramic printing block is lying on the space assigned to it. The subsequent supply of printing blocks is blocked when a printing block is incorrectly occupying and continued when a printing block is correctly stored, as described above.

The printing machines in which the described printing block assigning means is used can be rotary printing machines, preferably using offset printing methods, or roller rotary printing machines. The block cylinders to which the printing storages are assigned can be occupied once, twice or multiple times in the circumferential direction and can accommodate one, two, four, six or any other number of printing blocks in the longitudinal direction.

A method for verifying the storage of a printing block on the storage space of a printing block storage of a rotary printing machine or roller rotary printing machine which is assigned to it is also claimed, wherein the printing blocks are media for information which can be received, processed and stored via an identification means and which unambiguously defines a printing block. Once the data of the printing block have been received by the identification means, the printing block can be stored on a storage space, wherein a detection signal is generated by a detector provided on the storage space and supplied to the identification means. The identification means can recognise, on the basis of the stored data of the printing block, whether the intended storage space and the actual storage space of the printing block are identical. If this is the case, the identification means can receive the data of the next printing block. If the intended storage space and the actual storage space do not correspond, a signal which the operator can perceive by the senses is generated. The operator then has to correct the error before he can continue the process of storage space occupancy.

The identification means can be released, in order to continue to read printing block data, by the operator from the control panel of the machine, once the incorrectly stored printing block has been removed again from the printing storage space, or automatically as soon as the incorrect occupancy has been eliminated, wherein it can be necessary, after the printing block has been removed, to read the data of the printing block which has been removed from the incorrect storage space into the identification means again, before it is inserted into the storage space assigned to it.

The invention also relates to a printing block storage as such. The storage can in particular be provided with a register means, by means of which the printing blocks can be conveyed out of the storage, true to register with respect to the side register of the block cylinder. Register bars preferably form the register means. The printing blocks preferably comprise register cavities in the region of their bent edges, with which the register bars engage when the printing blocks are conveyed. Although less preferred, it would also be possible to form the register bars as lateral guides on which the printing blocks are guided, true to register with the block cylinder, along their side edges pointing in the direction of feed. When guiding at the side edge, it would also be possible to provide, instead of continuous register bars, a number of discrete register elements, for example register pins, in the printing block storage. Guiding true to register at the side edge, however, requires a true-to-register blank of the respective printing block, while the printing blocks—at least in roller rotary printing—are alone by their very nature usually provided with at least one register cavity each in the bent edge, which is advantageously used for guiding in register in the printing block storage in accordance with the invention.

The register means preferably comprises at least one guiding tongue per storage space for the new printing blocks, which protrudes beyond the front end of the support in the direction of feed onto the block cylinder and can be elastically bent or pivoted. By means of such guiding tongues, the printing blocks can be directly guided true to register at their front ends, up to the block cylinder. A guiding tongue which can be elastically bent in its own right is preferable over a guiding tongue which is rigid in its own right but can be pivoted against a spring force generated in some other way. In advantageous embodiments, the guiding tongues lengthen the register bars mentioned in the direction of feed, i.e. the register bars can be elastically bent or pivoted at their front free ends, so to speak.

If the new printing blocks are not to be illustrated until they are on the block cylinder, then guiding in register in the printing block storage can be omitted.

The supports can also each be fitted with a locking means which in the storage position holds the respective printing block in a locking connection with respect to the direction of feed and preferably also in a retracted position in which the relevant printing block is pressed into a clamping channel of the block cylinder. The locking means can in particular be formed on a register bar, in order to form the locking connection with one of the two bent edges of the respective printing block, preferably the rear bent edge. It is also still in principle advantageous if the locking means only establishes one of these locking connections with the respective printing block. The one or two releasable locking connections can in principle also be replaced by a simple positive lock.

The conveying means is preferably configured such that it conveys the respective printing block in the direction of feed to a position, preferably a locking position, in which a front bent edge of the printing block can be inserted into the clamping channel of the block cylinder. The conveying means comprises at least one, preferably exactly one, conveying member which in preferred embodiments acts as an urging member. The conveying member urges the relevant printing block in the direction of feed, preferably by urging the printing block in the direction of feed. An absolute pressing contact is preferred for transmitting a force which acts only in the direction of feed. The conveying means does not therefore immediately have to take up the relevant printing block, as would for example be required when using suckers, which however are not to be excluded from the outset from use as a conveying member or members, nor other types of conveying members.

In order to convey printing blocks used in previous production away from the block cylinder, preferred developments of the storage also comprise another, third support for at least one used printing block. For a block cylinder comprising at least a double circumference, the storage also comprises at least a fourth support for a fourth printing block sequential to the third printing block over the circumference of the block cylinder. For block cylinders of even greater circumference, the storage preferably comprises as many supports for new printing blocks, one on top of the other, as can be arranged successively on the block cylinder in the circumferential direction.

The same also preferably applies to the used printing blocks. If the block cylinder can be occupied by multiple printing blocks in the axial direction, as is usual, each of the supports is composed of individual supports corresponding to the number of printing blocks arranged next to each other. The storage for the new printing blocks and the storage for the used printing blocks preferably form an integrated storage which is assembled as a unit. They can however also be embodied to be physically separate from each other, in order for example to be able to selectively move one or the other to a working position, should the space available in the printing unit require this.

In order to likewise convey the used printing blocks to a storage position in the storage, the conveying means comprises at least one, preferably only one, conveying member which, preferably acting as a drawing member, draws the used printing block or multiple used printing blocks to its/their storage position/s. The conveying member acting as a drawing member is also preferably only in an absolute pressing contact with the relevant printing block, preferably against the bent edge of the printing block. The conveying member presses against the inner side of the bent edge, counter to the direction of feed, and so draws the printing block into the storage. The rotational movement of the block cylinder is preferably utilised, in order to convey the printing block into the storage, and the conveying member merely draws the printing block the last bit up to the storage position.

The conveying member for the new printing blocks and the conveying member for the used printing block(s) are advantageously the same. In preferred embodiments, the conveying member can be moved back and forth, both in and counter to the direction of feed and transverse to the direction of feed. The transverse movement serves for selecting the storage position from which the conveying member conveys the new printing blocks in the direction of feed and the used printing block counter to the direction of feed into the storage position. Alternatively, however, it would also in principle be possible to assign a first conveying member collectively to the new printing blocks and to likewise assign another, second conveying member collectively to the used printing blocks. In another alternative, each layer of printing blocks can be assigned a conveying member of its own. In the generally provided arrangement of multiple printing blocks next to each other, each of the printing blocks arranged next to each other can also be provided with conveying members of their own. At least for the multiple printing blocks arranged next to each other in the same layer, however, a collective conveying member is preferably provided for these, which extends over the entire axial width of the block cylinder which can be occupied by printing blocks. In particularly preferred embodiments, this is—as already mentioned—the only conveying member of the storage.

When using one or more conveying members which can be moved back and forth transverse to the direction of feed for selecting the printing block or blocks to be conveyed, the conveying member or members can advantageously be moved counter to the direction of feed up to a position in which it or they is/are situated behind the supports and the printing blocks accommodated in the storage, such that it or they can be moved transversely, unobstructed by structural parts of the storage. It or they can be moved out of this rear end position in the direction of feed, thus overlapping with the supports.

The conveying member or as applicable multiple conveying members can be moved preferably linearly in and counter to the direction of feed, advantageously by means of a spindle drive. The same advantageously applies to the preferred transverse movement. Linear movements can be more precisely performed than other types of movement which are in principle possible, for example a pivoting movement, in particular if the respective linear movement is generated by means of a spindle drive.

Although the printing blocks in the storage slide on their support—in the general case with respect to orientation, over their support—when the storage is orientated horizontally, it is alternatively possible for the supports to comprise rollers, on or over which the printing blocks are conveyed, wherein the rollers are only simply rotationally mounted, without a drive. In such an embodiment, the conveying means is preferably that shown. Alternatively, however, the rollers can also be rotary driven, in order to convey the respective printing blocks themselves. If a roller conveyor forms the conveying means itself, it can be sufficient for only one of the rollers or only one of the pairs of rollers, which should be arranged on a front end of the storage facing the block cylinder, to be rotary driven. The possibility is also not to be excluded that a belt conveyor forms the support, along which the printing blocks are conveyed lying on a conveyor belt.

In preferred embodiments, a storage cartridge which can be assembled and disassembled as a unit forms the storage for the new printing blocks. In one development, the same storage cartridge also accommodates the used printing blocks. In a likewise preferred alternative, however, such a storage cartridge only forms the storage for the new printing blocks, while the storage for the used printing blocks is another storage cartridge or accommodates the used printing blocks in an integrated storage which is fixedly assembled on the printing unit. A dichotomy has the advantage that the storage cartridge for the new printing blocks is lighter than a storage cartridge for all the printing blocks of the block cylinder and can therefore be more easily transported by the operating staff or by a robot.

The sequence of the storage spaces is in principle arbitrary. In a first preferred sequence, the storage comprises two upper storage spaces for the used printing blocks and two lower storage spaces for the new printing blocks, with respect to a horizontal orientation in the printing unit. In a second preferred sequence, the storage spaces for two new printing blocks are arranged between the storage spaces for two used printing blocks. The storage spaces for new printing blocks can be configured like that storage spaces for used printing blocks, but preferably differ.

In one advantageous development within the printing unit, the entire storage or at least a part of the storage can be moved from a working position close to the block cylinder to a maintenance position away from the block cylinder, in order to be able to free up the space for maintenance and repair work, which is generally restricted in printing units.

A particular feature of one development of the printing block storage is securing the printing blocks, in particular the new printing blocks, against movements such as can be caused by vibrations. Vibrations can be caused in the printing unit by machine operations or while the storage—for example, a storage cartridge formed as a quick-assembly unit—is being transported, and can in particular cause the printing blocks to be moved out of their defined storage positions. In order to prevent such movements, the storage advantageously comprises a holding means. In preferred embodiments, the holding means is formed as a clamping means which holds the printing blocks in a clamping force which on the one hand is large enough to prevent undesirable movements due to vibrations, but on the other hand does not obstruct the conveying activity of the conveying means, at least not to an extent which is relevant in practice. Preferably, the supports form such a holding means, preferably a clamping means. For this purpose, the supports can be shaped like a wave in the direction of feed, in the form of a wave which is transversal with respect to the respectively held printing block. In such an embodiment, each of the supports for the new printing blocks—and, as applicable, the supports for the used printing blocks—comprises two mutually facing abutment areas which contact the held printing block on both its flat sides, wherein the contact is between the printing block and a crest of the wave of the respective abutment area in each case. The two abutment areas preferably run parallel to each other, though this is not absolutely necessary. The amplitude or, as applicable, the different amplitudes of the wave are selected such that the held printing block is slightly bent, just enough to generate the clamping force required for holding. Instead of a proper waveform, the abutment areas can also merely describe a single arc, such that the respective printing block is simply only correspondingly bent over it length as measured in the circumferential direction of the block cylinder. Instead of a wave-shaped or merely arc-shaped profile over their entire length, each of the abutment areas can also merely be bent in a short length region or provided with a cavity or shaped in some other way in order to slightly bend the respectively held printing block and thus hold it in a slight clamping force. In another alternative embodiment, the storage can be provided with at least one spring means for each support, which due to its elasticity force presses the respectively held printing block against the support and thus generates the clamping force, or the spring means alone forms the support. While a clamping means with a bent or wave-shaped profile of the supports or an alternative solution which slightly bends the printing blocks is preferred for the supports of the new printing blocks, it is preferable for the used printing blocks if their respective support is formed directly by a spring element or preferably multiple spring elements. The used printing blocks—or also, as applicable, only one used printing block—preferably lies on such a support via its lower side facing away from the image side.

In the printing unit, the printing block storage is preferably installed such that the printing blocks are conveyed in and out of the storage at least substantially horizontally. However, installations are also conceivable in which the printing block storage is oblique or even vertical with respect to the block cylinder for conveying. In this case, it can be necessary to rotate individual block cylinders in the direction counter to the printing direction, when depositing the printing blocks.

The supports, in particular the supports for the new printing blocks, preferably only contact the printing blocks on their side edges outside the printing area. If, as is preferred, the printing block storage comprises lateral guides which guide the printing blocks at the side edges in addition to the respective register means or as applicable alone, acting as the register means, said lateral guides can advantageously form the supports. Lateral guides which fulfil a combination of the functions of lateral guiding and the function of the respective support are in particular preferred for the new printing blocks.

In the printing unit, the printing block storage preferably co-operates with a printing block changing device which comprises lifting members and pressing members arranged next to each other in the axial direction of the block cylinder. At least one lifting member and one pressing member is provided for each of the printing blocks arranged axially next to each other. The lifting members can in particular be suckers. The pressing members can in particular be rollers for rolling over the printing blocks. The conveying means conveys the new printing blocks from the supports onto the block cylinder, where they are pressed into the clamping channels by means of the pressing members. The block cylinder is then rotated such that printing blocks already suspended in the clamping channel are drawn out of the storage by the rotational movement. The lifting members are used to remove used printing blocks from the block cylinder. When the relevant end of the used printing blocks is free of the block cylinder, the holding engagement of the lifting members is released. The block cylinder is then rotated such that the used printing blocks move into the storage. Once the other end of the printing block has likewise been released from the block cylinder, namely by means of at least one lifting member, the printing block is preferably drawn the last bit into the storage by the conveying means. The printing block storage, the printing block changing device and the block cylinder preferably form a fully automatic printing block changing system.

An axially continuous suppressor, or multiple suppressors axially next to each other, are preferably provided in order to hold the ends of the printing blocks down while the printing blocks are changed. The at least one suppressor holds the ends of the used printing blocks down such that they are urged onto the supports of the storage provided for them when the block cylinder is rotated. Instead or additionally, the at least one suppressor is used to press-in the front ends of the new printing blocks. In principle, the pressing members could form the at least one suppressor. It is advantageously provided, however, in addition to the lifting members and pressing members and arranged between the storage and the lifting members and pressing members in the direction of feed.

The printing block storage can in particular be used in combination with a printing block changing device such as is described in DE 10 2004 023 434 and PCT/EP2005/004937, to which reference is made with respect to the printing block changing device. The printing block changing device—described in said documents primarily as a semi-automatic device—advantageously forms a fully automatic printing block changing system in co-operation with the printing block storage and the block cylinder.

### BRIEF DESCRIPTION OF THE DRAWINGS

An example embodiment of the invention is explained below on the basis of figures. Features disclosed by the example embodiment, each individually and in any combination of features, advantageously develop the embodiments described herein. There is shown:

FIG. 1 is an elevation view of a printing machine comprising identification means fixed to the frame;

FIG. 2 is a perspective view of a printing block comprising a register bar;

FIG. 3 is an elevation view of a printing block at the storage space, comprising detectors;

FIG. 4 is a perspective view of a printing block storage;

FIG. 5 is a side view of a printing block storage in a longitudinal section;

FIG. 6 is a storage cartridge of the printing block storage in a perspective view onto a front end;

FIG. 7 is a storage cartridge in a perspective view onto a rear end.

### DETAILED DESCRIPTION OF THE PREFERRED EMBODIMENTS

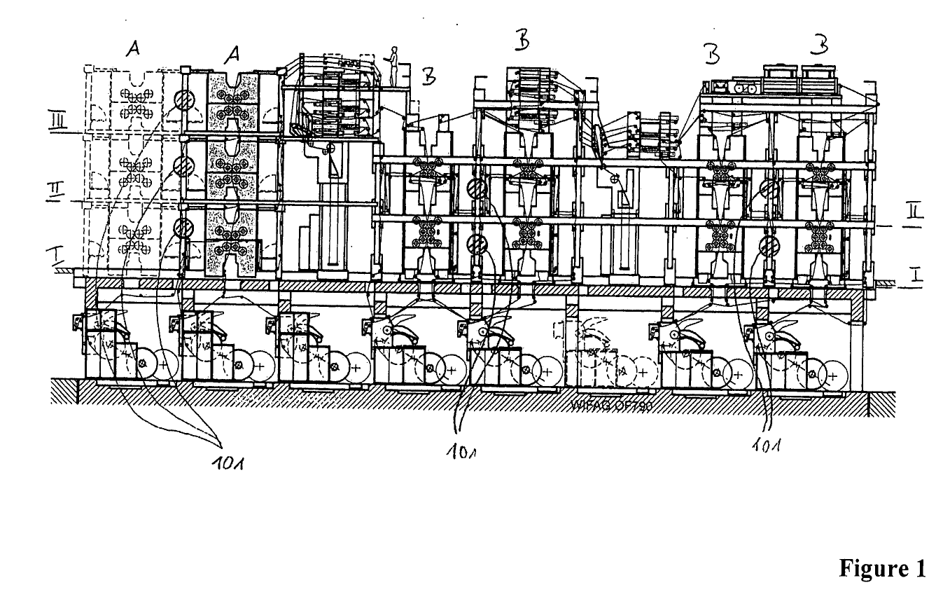

FIG. 1 shows a roller rotary printing machine comprising two printing towers A, each comprising three H-bridges arranged one on top of the other, and four printing towers B, each comprising two ten-cylinder printing units. An identification means 101 or a sensor of the identification means 101 is fixed to the machine frame on each working level I, II, III between each two printing towers. At each of the operating spaces provided with an identification means 101, the operating staff can occupy the printing block storages 102 (not shown) of the two adjoining printing units. The correct storage of the printing blocks 1 at the respective storage spaces 102a can then be monitored by means of respective identification means 101. To this end, the respective identification means 101 can call up the occupancy plan of the assigned printing block storages 102, which is stored in an internal data memory or in an external data memory—comprised for example by a machine controller—and can compare this intended occupancy plan with the respective actual occupancy state at a respective printing block storage space 102a. When all the printing blocks 1 have been confirmed as lying at their correct storage space 102a, the identification means 101 generates a confirmation signal and transmits it, for example, to the machine controller. If multiple identification means 101 are provided on one machine, then each individual identification means 101 must transmit the confirmation signal to the machine controller before the printing blocks 1 are released for automatically changing the printing plates.

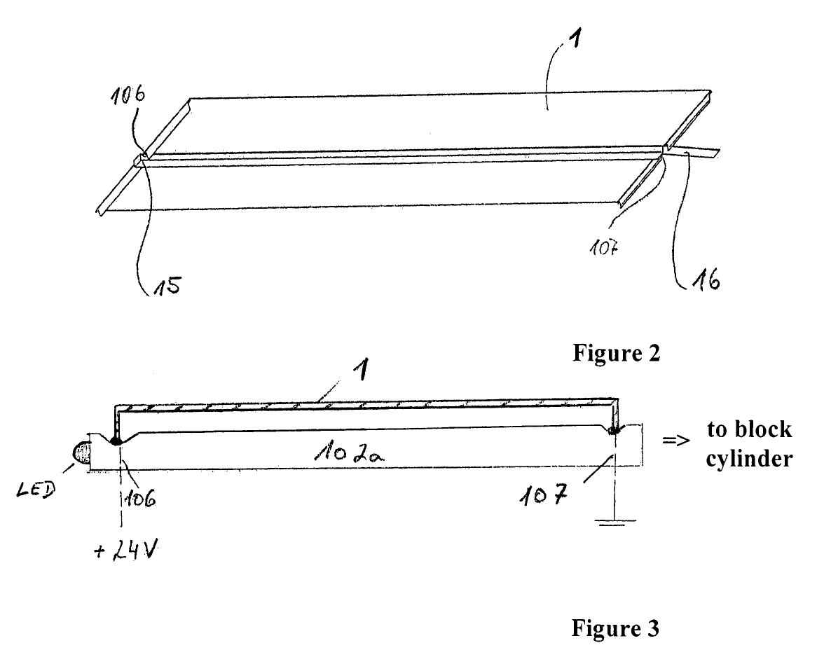

FIG. 2 shows the bottom view of a printing block 1 lying on a storage space. Only a register bar 15 of the storage space is shown, on which the printing block 1 rests and which ensures that the printing block 1 is positioned true to register. At the end of the storage space 102a facing the block cylinder 6, the register bar 15 comprises a guiding tongue 16 lengthening it.

FIG. 3 shows a printing block 1, consisting of a conductive material, on a storage space 102a. Each of the two ends of the printing block 1 comes to rest on a contact 106, 107 supplied with a current. The printing block 1 thus closes the circuit and generates a detection signal indicating the presence of a printing block 1 on the storage space 102a of the identification means 101. A signal which is perceptible by the senses, e.g. a light-emitting diode, can simultaneously signal, directly at the storage space 102a, that the storage space is occupied. The signal which is perceptible by the senses is activated by the identification means 101. When using light-emitting diodes, the diode is advantageously illuminated such that a green light is illuminated when the printing block is lying on the storage space 102a assigned to it, and a red light when the printing block 1 has been stored on an incorrect storage space 102a and/or as long as a printing block 1 has not been inserted into the storage space 102a. As long as the red light is illuminated, the identification means 101 cannot receive data from another printing block 1. Only once the printing block 1 has been removed from the incorrect storage space 102a and inserted into the correct storage space 102a and confirmed as such by the detectors 104 provided in said storage space is the identification means 101 ready to receive subsequent printing block data.

In a preferred embodiment, only the contact point 106 assigned to the trailing end of the printing block 1 is supplied with a current, while the leading end is connected to a neutral conductor 107. The printing block 1 thus generates a short-circuit when it is inserted into the storage space 102a. The short-circuit current thus arising then generates the detection signal. For printing block storages 10 comprising multiple storage spaces 102a, it is particularly preferable to not provide a neutral conductor 107 for each storage space 102a. In this case, all the neutral conductors 107 are connected to each other and form an earth cable which contacts all the printing blocks 1 of a printing block storage 10.

When using panoramic printing blocks, the identification means 101 is capable of deducing from the information on the printing block 1 that two detection signals are necessary for correctly storing the panoramic printing block on the assigned storage spaces 102a, in order to reliably confirm that it has been correctly stored. The identification means 101 can also process this information and confirm that the panoramic printing block has been correctly stored or indicate by a signal which is perceptible by the senses that it has been incorrectly stored. Preferably, the information of one detector is also sufficient for detecting a panoramic printing block, which can for example be achieved by assigning only one of the two storage spaces 102a needed to the panoramic printing block in the occupancy plan for the next production and storing the other storage space 102a in the occupancy plan either as already correctly occupied or free in principle.

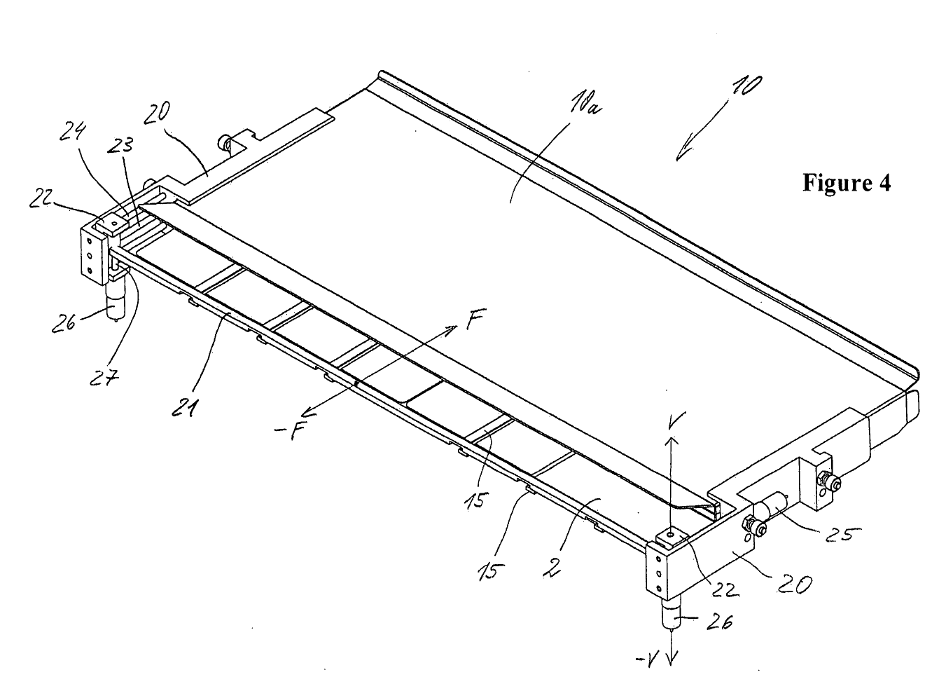

FIG. 4 shows one of the storages. The storage 10 consists of a storage cartridge 10a comprising shafts arranged one on top of the other. The number of shafts arranged one on top of the other corresponds to twice the number of printing blocks arranged successively over the circumference of the block cylinder 6. Each of the shafts encompasses as many printing blocks, lying next to each other, as are arranged axially next to each other on the block cylinder 6. In the example embodiment, the block cylinders 6 each have a double circumference and are four sides wide. A maximum of two printing blocks are thus arranged successively in the circumferential direction. Four single-width printing blocks or two so-called panoramic printing blocks can in particular be arranged next to each other in the axial direction. Two single-width printing blocks can also be arranged next to one panoramic printing block. In principle, the block cylinders 6 can also be modified to exhibit a more than double circumference. Equally, the block cylinders can either be narrower, in the extreme only one side wide, or wider, for example six sides wide. The storage 10 or storage cartridge 10a is correspondingly narrower or wider, such that each of its shafts can encompass as many printing blocks next to each other as are or can be arranged next to each other on the block cylinder 6. In this respect, the width of the storage 10 corresponds to the width of the block cylinder 6.

The storage 10 also comprises two conveying attachments 20 which are detachably assembled on the two lateral edges of the storage cartridge 10a. The conveying attachments 20 mount the components of a conveying means. In the case of a printing block change, new printing blocks can be conveyed in a direction of feed F onto the assigned block cylinder 6 by means of the conveying means. The conveying means also serves to convey used printing blocks in the opposite direction −F, into the storage 10.

The conveying means comprises a conveying member 21 in the form of a rod-shaped crossbar which extends over the entire width of the storage cartridge 10a and is fixed at each of its two ends to a driven member 22, such that it cannot move with respect to the direction of feed F. The driven members 22 are the running members of a linear drive for the direction of feed F and the opposite direction −F. The driven members 22 and together with them the conveying member 21 can be linearly moved back and forth in the direction of feed F and the opposite direction −F. The linear drive comprises two drive members which are arranged on the two side edges outside the storage cartridge 10a and mounted by the two conveying attachments 20 as already mentioned. The driven members 22 are the nuts of two spindle drives which each comprise, in addition to the nut, a spindle 23 extending in the direction of feed F as a drive member and at least one linear guide 24. The spindles 23 are rotary driven by motors 25. When the spindles 23 are rotary driven, the driven members 22 move back and forth in accordance with the rotational direction of the spindles 23, due to their linear guides. This movement parallel to the shafts of the storage cartridge 10a conveys the printing blocks in or out of the storage 10.

When moved in the direction of feed F, the conveying member 21 presses against the rear bent edges, facing away from the block cylinder 6, of the printing blocks accommodated in the respective shaft. It is a loose pressing contact, such that the conveying member 21 is detached from the respective printing blocks simply by being moved in the direction −F. When conveying used printing blocks into the storage 10, the conveying member 21 is moved among the printing blocks which are partially inserted into the assigned shaft and against the inner side of the (in the direction −F) front bent edges, such that when the conveying member 21 moves in the direction −F, it draws the used printing blocks, pressing loosely against the inner sides of the bent edges, deeper into the storage 10. Within each of the shafts for the used printing blocks, there is still enough space beneath the printing blocks that the conveying member 21 can move under and past the bent edges, to beneath the printing blocks. As soon as it has passed the bent edges, it is moved slightly towards the lower side of the printing blocks until it overlaps with the bent edges.

The motors 25 are supported on the respective conveying attachment 20. Their motor shafts point parallel to the direction of feed F.

The conveying means also comprises another linear drive, by means of which the conveying member 21 can be moved back and forth transverse—in the example embodiment, perpendicular—to the direction of feed F, in order to convey the printing blocks accommodated or to be accommodated in each of the shafts of the storage cartridge 10a arranged one on top of the other. The second linear drive consists of the conveying member 21 directly as a driven or running member, and the two driven members 22 of the former linear drive which as guiding members each form the drive member in the other linear drive. The other linear drive is also formed as a spindle drive. The two end regions of the conveying member 21 are accordingly each formed as a nut. The driven members 22 each comprises a spindle 27. The spindles 27 are perpendicular to the spindles 23. Another motor 26 is supported on each of the driven members 22 in order to rotary drive the spindles 27. When the spindles 27 are rotary driven by the respectively assigned motor 26, the conveying member 21 is moved along the spindles 27, perpendicular to the direction of feed F, in accordance with the rotational direction, in order to move to the selected shaft. The conveying member 21 performs this selecting movement in a rear end position, shown in FIG. 3, in which it is free of the storage cartridge 10a. The axis of the transverse movement of the conveying member 21 is indicated by V/−V. The two motors 26 for the transverse movement and the two motors 25 for the longitudinal movement are electronically synchronised within the pairs of motors 25 and 26. The motor shafts of the motors 26 point parallel to the direction V of the transverse movement of the conveying member 21.

Apart from differences arising from their axial symmetry, the two conveying attachments 20 are identical, including the movably mounted components of the conveying means. The conveying attachments 20 serve not only to mount the components of the conveying means but also to assemble and guide the storage 10 on the side walls of the printing unit.

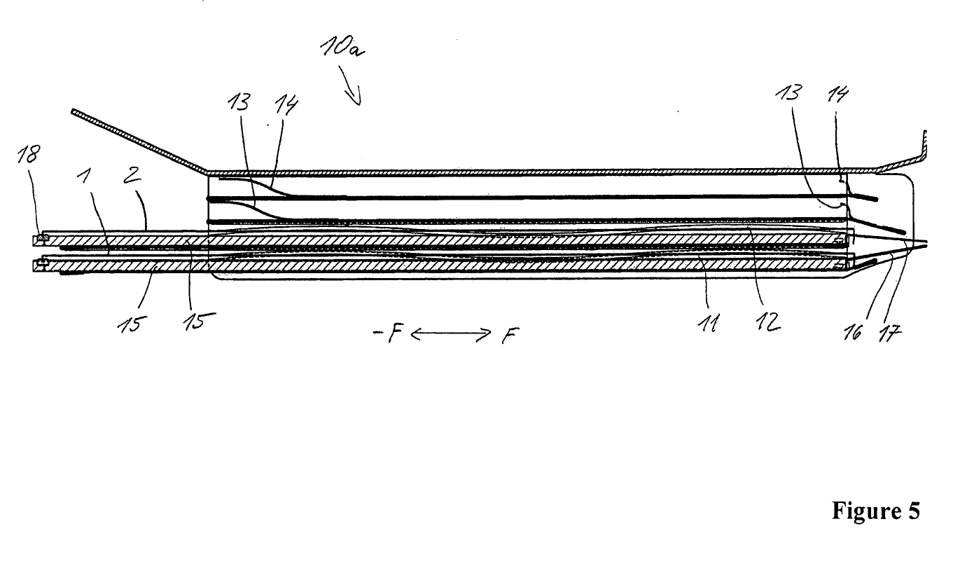

FIG. 5 shows the storage cartridge 10a in a longitudinal section. The storage cartridge 10a comprises a total of four shafts arranged one on top of the other. The two lower shafts each accommodate a layer of new printing blocks 1 and 2 with which the assigned block cylinder 6 for the next production is to be loaded. The used printing blocks of the previous production can be accommodated in the two upper shafts. In a production change, the used printing blocks are conveyed into the two upper shafts and the new printing blocks 1 and 2 are conveyed out of the two lower shafts. Supports are formed in each of the shafts for the printing blocks accommodated or to be accommodated in the respective shaft. The first new printing blocks 1 to be arranged next to each other on the block cylinder are accommodated in the lowest shaft, lying on first supports 11. The next, second new printing blocks 2 to be attached next to each other on the block cylinder 6 are accommodated in the next shaft arranged above that, lying on second supports 12. The two shafts arranged above that are empty for the used printing blocks.

The new printing blocks 1 and 2 each assume a predetermined storage position. The printing blocks 1 and 2 are each detachably connected, in a positive lock, to the storage cartridge 10a in their storage position. In the example embodiment, they are each connected to the storage cartridge 10a by means of a detachable locking connection. The connection is such that the storage position is defined with respect to the direction of feed F, but can be directly released by the conveying member 21 pressing against the printing blocks 1 and 2 in the direction of feed F.

The supports 11 and 12 are shaped such that they hold the printing blocks 1 and 2 clamped in a well-regulated non-positive lock. To this end, the supports 11 and 12 are each formed as a pair of abutment areas facing each other via the held printing block 1 or 2. The two abutment areas of each support 11 and 12 run parallel to each other in the direction of feed F, in the shape of a wave, such that a wave-shaped slit results in the longitudinal section, in which slit the respective printing block 1 or 2 is enclosed in a slight non-positive lock along one of its two side edges and slightly bent in accordance with the wave-shaped profile of the respective support 11 or 12 in the direction of feed F.

Register bars 15 are arranged within the shafts for the new printing blocks 1 and 2, on which the printing blocks 1 and 2 are conveyed in the direction of feed F with respect to the side register, true to register with the block cylinder 6. The register bars 15 also each form the positive-lock connection for predetermining the storage position. For this purpose, they each form a positive-lock element 18, for example a locking element, at their rear ends. The rear bent edges of each of the printing blocks 1 and 2 protrude into a recess of the positive-lock element 18. The front and rear bent edges of the printing blocks 1 and 2 are each provided with at least one cavity, with each of which one of the register bars 15 engages in an exact fit and so guides the relevant printing block 1 or 2 true to register when it moves in the direction of feed. In the region of the cavities of the bent edges, a short bent edge stump respectively remains with which the printing blocks 1 and 2 form the positive-lock connection to the storage cartridge 10a—in the example embodiment, with the positive-lock elements 18.

The shafts for the new printing blocks 1 and 2 each exhibit a height, measured perpendicular to the direction of feed F, which corresponds at least substantially to the height of the register bar or bars 15 arranged in the respective shaft, plus the amplitude of the supports 11 and 12. This height is smaller than twice the length of the bent edges of the printing blocks 1 and 2; in the example embodiment, the height of the shafts corresponds to about one and a half times the length of the bent edges.

The register bars 15 extend in the direction of feed F up to the front end of the storage cartridge 10a, at which the printing blocks 1 and 2 exit the storage cartridge 10a. They are each lengthened in the direction of feed F by an elastically bending guiding tongue. The guiding tongues for the first printing blocks 1 are indicated by 16 and the guiding tongues for the second printing blocks 2 are indicated by 17. The guiding tongues 16 and 17 point towards each other at an acute angle in the direction of their front free ends, wherein the lower guiding tongues 16 are inclined upwards and the upper guiding tongues 17 are inclined downwards. The guiding tongues 16 and 17 are as wide as the register bars 15, but substantially thinner and therefore elastically bending. In the working position of the storage 10, the guiding tongues 16 and 17 protrude just beyond the clamping channel of the block cylinder 6 as viewed in the radial direction of the block cylinder 6, and up to or preferably even slightly overlapping with the clamping channel as viewed in the circumferential direction.

Supports 13 and 14 are likewise formed in the shafts for the used printing blocks. The supports 13 and 14 are spring means—in the example embodiment, a pair of spring elements in each case—arranged at each of the front and rear end of the storage cartridge 10a in the side edge region of the printing blocks to be accommodated. The spring elements 13 and 14 are formed as freely oscillating leaf springs which deflect under the weight of the entering printing block. The front spring elements 13 and 14 facing the block cylinder 6 preferably extend beneath the bent edges of the printing blocks to be accommodated or as applicable are also arranged away from the side edges, such that the bent edges of the used printing blocks slide over the front spring elements 13 or 14 and the front spring elements 13 and 14 thus prevent the used printing blocks from being able to move back onto the block cylinder 6 again while being removed from the block cylinder 6. The shafts for the used printing blocks are similarly flat to the shafts for the new printing blocks 1 and 2.

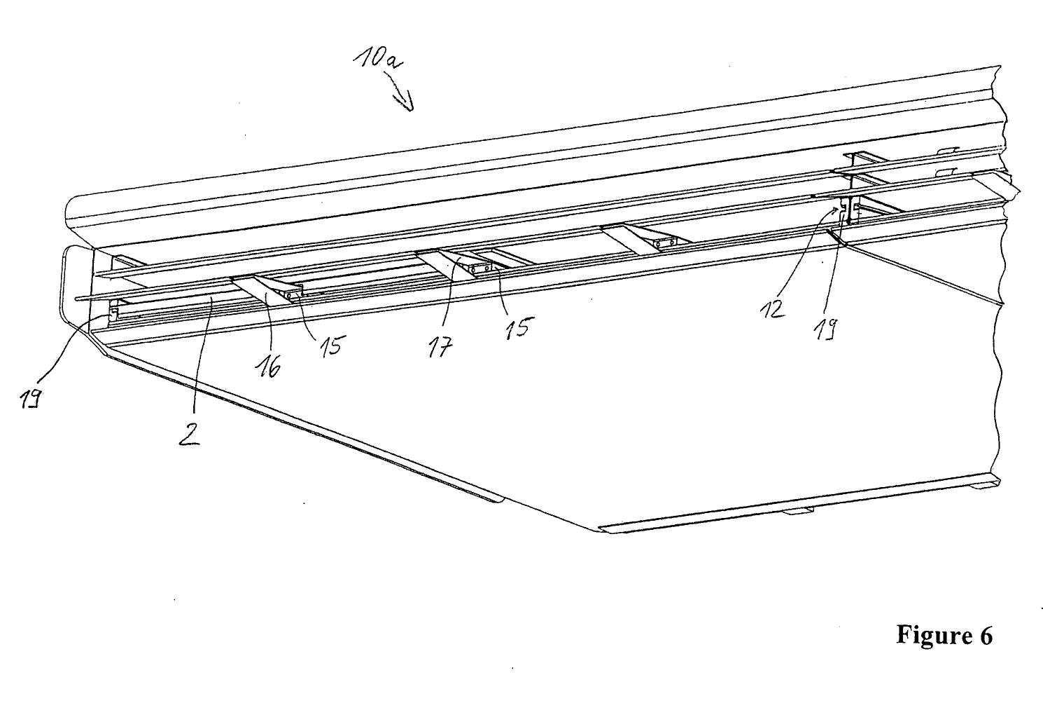

FIG. 6 shows the storage cartridge 10a in a perspective view onto its front end, in which inter alia the front ends of the register bars 15 and the guiding tongues 16 and 17 lengthening them can be seen. As can also be seen, the supports 11 and 12—of which only the supports 12 can be seen—are part of the side edge guides 19. The side edge guides 19 each exhibit the shape of a horizontal U. The two parallel limbs of the U form the abutment areas of the supports 11 and 12 in the form of the arc-shaped—i.e. in the example embodiment, wave-shaped—clamping channel. In addition to the register bars 15 and guiding tongues 16 and 17, the connecting limb of the U serves as a lateral guide for the printing blocks 1 and 2. As can also be seen, the lateral guides 19 subdivide the shafts for the printing blocks 1 and 2 into two compartments each. Either one double-width printing block or two single-width printing blocks 1 or 2 can be accommodated in each of the compartments. The double-width printing block is guided on both sides on the side edge guides 19 and on both sides lies on the abutment areas of the supports 11 and 12 formed there. The two single-width printing blocks 1 or 2 are only laterally guided on one edge and also only contact one of the supports 11 and 12 on this edge. Three register bars 15, spaced from each other in parallel, and guiding tongues 16 or 17 are also correspondingly provided for each compartment. If the respective compartment only accommodates two single-width printing blocks 1 or 2, the middle register bar 15 merely serves as a support in addition to the supports 11 and 12 on the other side edge of the respective printing block 1 or 2. This support 15 does not assume a clamping function. The bent edges of the printing blocks 1 and 2 are correspondingly relieved on their side edges, such that single-width printing blocks 1 and 2 can slide along one of the supports 11 and 12 on one side edge and along the register bar 15 on its other side edge. A second single-width printing block 2 with a cavity in the bent edge is shown by way of example. Double-width printing blocks are provided with three cavities each on their bent edges, but are only guided in register by the middle register bar 15; single-width printing blocks are each guided by one of the two other register bars 15.

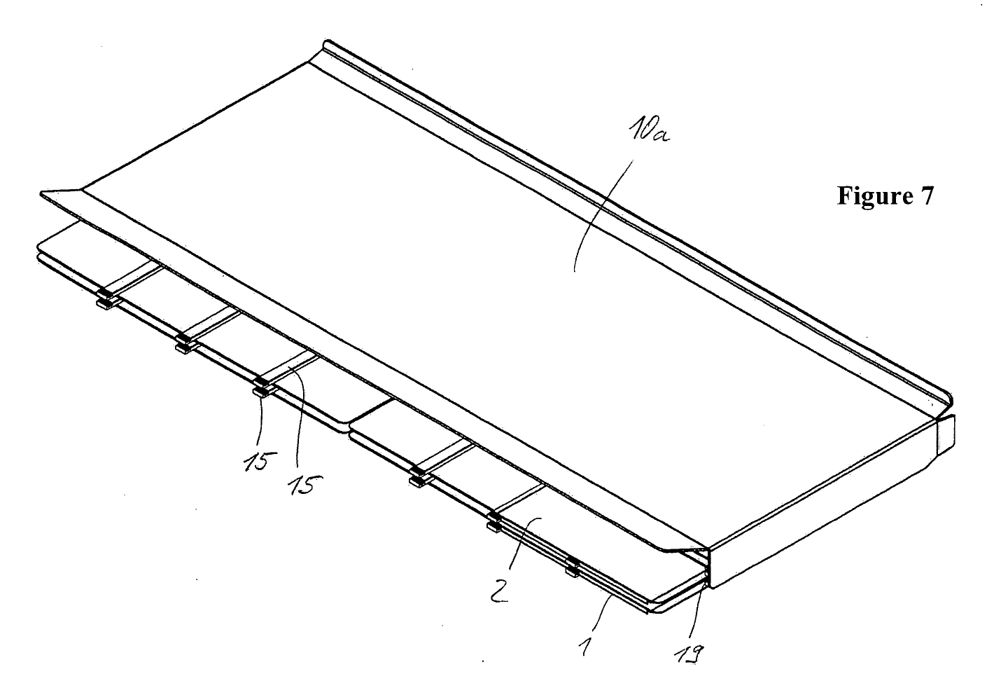

FIG. 7 shows the storage cartridge 10a in a perspective view onto its rear end. Two new single-width printing blocks 1 and 2 are accommodated, one on top of the other, in the two lower shafts on the right-hand edge in the figure. The other storage spaces are empty.

1. A printing block assigning system for one or more block cylinders of a rotary printing machine, comprising:
a printing block storage comprising storage spaces for printing blocks which can be deposited on the block cylinder;
a detector for each storage space for detecting a printing block respectively occupying the storage space and outputting a detection signal; and
an identification means for receiving, processing and storing information which individually identifies the respective printing block is situated outside the printing block storage; wherein the detection signals of the detectors are supplied to the identification means; and the identification means detects whether the printing blocks are situated on the storage spaces respectively assigned to them, on the basis of a comparison between the information received from the printing blocks and the received detection signals.

2. The printing block assigning system according to claim 1, wherein the identification means monitors the printing block storage occupancy for two or more block cylinders.

3. The printing block assigning system according to claim 1, wherein the identification means comprises at least one sensor for receiving and relaying the printing block data and a data processing means.

4. The printing block assigning system according to claim 3, wherein the data processing means is part of a central machine controller of the printing machine or a part of an independent central machine controller.

5. The printing block assigning system according to claim 3, wherein the data processing means of the identification means stores an occupancy plan of a next printing production.

6. The printing block assigning system according to claim 3, wherein the data transmitted from the at least one sensor is compared with the stored data of the occupancy plan by means of the data processing means.

7. The printing block assigning system according to claim 1, wherein the identification means is a mobile means which is guided by an operator to the printing block or printing blocks.

8. The printing block assigning system according to claim 3, wherein the sensor forms a structural unit together with the data processing means, and said structural unit is fixed to a structural part, component or attachment of the machine.

9. The printing block assigning system according to claim 1, wherein the identification means includes at least one sensor arranged between two printing locations or between two printing bridges or between two printing towers on a working level and serves to receive and compare the data of all the printing blocks provided for the corresponding block cylinders.

10. The printing block assigning system according to claim 9, wherein in printing machines comprising two printing towers arranged successively with respect to a direction of feed of the machine, at least two sensors of the identification means are arranged between the printing towers on at least one of the working levels.

11. The printing block assigning system according to claim 1, wherein the identification means comprises a blocking means which blocks the identification means once the data of a first printing block has been received, and only releases the identification means for receiving the information of a second printing block once it has been detected that the first printing block has been stored at the correct storage space.

12. The printing block assigning system according to claim 1, wherein a signal transmitter of the identification means outputs a signal which is perceptible by the senses when an incorrect occupancy or the absence of a printing block on an assigned storage space is detected.

13. The printing block assigning system according to claim 11, wherein the blocking means does not release the printing blocks for a printing block change until all the printing blocks are lying on their predetermined storage spaces.

14. The printing block assigning system according to claim 1, wherein the detectors provided at the storage spaces only distinguish between the states “printing block absent” and “printing block present”.

15. The printing block assigning system according to claim 1, wherein the detectors each comprise two spaced contacts, supplied with a current, which are closed by inserting a printing block including a conductive material and thus generate the detection signal and transmit it to the identification means.

16. The printing block assigning system according to claim 15, wherein only one of the two contacts of each storage space is supplied with a current, the other contact serving as a neutral conductor.

17. The printing block assigning system according to claim 16, wherein connecting the contact supplied with current to the neutral conductor generates a short-circuit, and a short-circuit current thus arising generates the detection signal and transmits it to the identification means.

18. The printing block assigning system according to claim 17, wherein signal means which are perceptible by the senses are integrated into the short-circuit and activated by the signal transmitter of the identification means.

19. The printing block assigning system according to claim 16, wherein the contacts forming the neutral conductor of all the storage spaces of a printing block storage are connected to form a collective neutral conductor.

20. A method for verifying the storage of a printing block on a storage space of a printing block storage of a rotary printing machine or roller rotary printing machine which is assigned to it, wherein the printing block carries information which is received, processed and stored by an identification means, comprising:
a) receiving the information of a printing block by the identification means once the printing block is stored on the storage space of the printing block storage;
b) activating a detector which generates a detection signal and supplies it to the identification means; and
c) determining with the identification means whether the intended storage space of the printing block is the same as the actual storage space of the printing block.

21. The method according to claim 20, wherein if the intended storage space and the actual storage space correspond, a next printing block is supplied to the identification means.

22. The method according to claim 20, wherein the identification means monitors the printing block storage occupancy for two or more block cylinders.

23. The method according to claim 20, wherein the identification means only receives the information of a second printing block once it has been detected that a first printing block has been stored at the correct storage space.

24. The method according to claim 20, wherein a signal which is perceptible by the senses is released by a signal transmitter of the identification means when an incorrect occupancy or the absence of a printing block on the assigned storage space is detected.

25. The method according to claim 20, wherein the printing blocks are blocked from a printing block change by a blocking means until all the printing blocks are lying on the storage spaces predetermined by the occupancy plan stored in a memory of the identification means.

26. The method according to claim 20, wherein only the states “printing block absent” and “printing block present” are distinguished by the detectors provided at the storage spaces.

27. The method according to claim 20, wherein the detectors comprise two spaced contacts, supplied with a current, which are closed by inserting a printing block including a conductive material.

28. The method according to claim 27, wherein only one of the two contacts of each storage space is supplied with a current, the other contact serving as a neutral conductor.

29. The method according to claim 28, wherein connecting the contact supplied with current to the neutral conductor generates a short-circuit which is detected and processed by the identification means.

30. The method according to claim 29, wherein signal means which are perceptible by the senses are integrated into the short-circuit and activated by the signal transmitter of the identification means.

31. The method according to claim 28, wherein the contacts forming the neutral conductor of all the storage spaces of a printing block storage are connected to form a collective neutral conductor.

32. The printing block assigning system according to claim 3, wherein the data processing means is a microprocessor.

33. The printing block assigning system according to claim 3, wherein the sensor is fixed to a structural part, component or attachment of the machine and the data processing means is situated at another location on the rotary printing machine.

34. The printing block assigning system according to claim 18, wherein the signal means includes light-emitting diodes.

35. The method according to claim 30, wherein the signal means include light-emitting diodes.
